(19) United States
(12) Patent Application Publication
(10) Pub. No.: US 2007/0097027 A1
(43) Pub. Date: May 3, 2007

(54) Plasma display apparatus and method of driving the same

(75) Inventor: Seonghak Moon, Seoul (KR)

Correspondence Address: KED & ASSOCIATES, LLP, P.O. Box 221200, Chantilly, VA, 20153-1200, US

(73) Assignee: LG Electronics Inc.

(21) Appl. No.: 11/588,222

(22) Filed: Oct. 27, 2006

(30) Foreign Application Priority Data
Oct. 28, 2005 (KR) 10-2005-0102302

(51) Int. Cl. G09G 3/28

(52) U.S. Cl. 345/60

(57) ABSTRACT

A plasma display apparatus and a method of driving the same are disclosed. The plasma display apparatus includes a plasma display panel including an electrode, and a driver. The driver supplies a second reset pulse to the electrode during a second frame when a variation between a load of video data of a first frame and a load of video data of the second frame is more than a threshold value. The second reset pulse supplied during the second frame generates a reset discharge, that is greater than a reset discharge generated by a first reset pulse supplied during the first frame.

This Nonprovisional application claims priority under 35 U.S.C. § 119(a) on Patent Application No. 10-2005-0102302 filed in Korea on Oct. 28, 2005 the entire contents of which are hereby incorporated by reference.

### BACKGROUND OF THE INVENTION

1. Field of the Invention

This document relates to a plasma display apparatus and a method of driving the same.

2. Description of the Related Art

A plasma display apparatus includes a plasma display panel and a driver for driving the plasma display panel. The driver supplies a driving pulse to the plasma display panel during a frame including a plurality of subfields such that an image is displayed on the plasma display panel.

Each subfield includes a reset period, an address period, and a sustain period. During the reset period, the driver supplies a reset pulse for uniforming wall charges formed in all of discharge cells of the plasma display panel. During the address period, the driver supplies a scan pulse and a data pulse for selecting discharges cells to be turned on. During the sustain period, the driver supplies a sustain pulse for emitting light in the discharge cells selected during the address period.

When the amount of wall charges formed in each discharge cell of the plasma display panel is not uniform during the reset period, selection of unnecessary discharge cells or non-selection of necessary discharge cells may occur due to the scan pulse and the data pulse supplied during the address period. This results in emission of light in the unnecessary discharge cells or non-emission of light in the necessary discharge cells during the sustain period.

Accordingly, it is important to uniform the amount of wall charges formed in all of the discharge cells of the plasma display panel during the reset period.

### SUMMARY OF THE INVENTION

In one aspect, a plasma display apparatus comprises a plasma display panel comprising an electrode, and a driver for supplying a second reset pulse to the elect during a second frame when a variation between a load of video data of a first frame and a load of video data of the second flame is more than a threshold value, the second reset pulse supplied during the second frame generating a reset discharge, that is greater than a reset discharge generated by a first reset pulse supplied during the first frame.

In another aspect, method of driving a plasma display apparatus comprising an electrode, the method comprises calculating a variation between a load of video data of a first frame and a load of video data of a second flame, comparing the variation with a threshold value, and supplying a second reset pulse to the electrode during a second frame when the variation is more than the threshold value, the second reset pulse supplied during the second frame generating a reset discharge, that is greater than a reset discharge generated by a first reset pulse supplied during the first frame.

### BRIEF DESCRIPTION OF THE DRAWINGS

The accompany drawings, which are included to provide a further understanding of the invention and are incorporated in and constitute a part of this specification, illustrate embodiments of the invention and together with the description serve to explain the principles of the invention.

FIG. 1 illustrates a plasma display apparatus according to an embodiment;

FIG. 2 illustrates a scan driver of the plasma display apparatus according to the embodiment;

FIGS. 3a and 3b illustrate a first reset pulse and a second reset pulse in a first frame and a second frame; and

FIG. 4 illustrates a subfield in which a second reset pulse is supplied.

### DETAILED DESCRIPTION OF PREFERRED EMBODIMENTS

Preferred embodiments of the present invention will be described in a more detailed manner with reference to the drawings.

A plasma display apparatus comprises a plasma display panel comprising an electrode, and a driver for supplying a second reset pulse to the electrode during a second frame when a variation between a load of video data of a first flame and a load of video data of the second flame is more than a threshold value, the second reset pulse supplied during the second flame generating a reset discharge, that is greater than a reset discharge generated by a first reset pulse supplied during the first frame.

A ratio of the threshold value to the larger load in the load of the video data of the first frame and the load of the video data of the second frame may be equal to or more than 0.2.

The variation may be equal to a difference between a sum of a gray level corresponding to each subpixel in the first frame and a sum of a gray level corresponding to each subpixel in the second frame.

The variation may be equal to a difference between a sum of an average gray level corresponding to each pixel in the first frame and a sum of an average gray level corresponding to each pixel in the second frame.

The driver may set at least one of a rising slope or the highest voltage of the second reset pulse to be more than at least one of a rising slope or the highest voltage of the first reset pulse.

The driver may comprise a switch for supplying the first reset pulse and the second reset pulse. The switch may receive a control signal having a first duty ratio, and then supplies the first reset pulse. The switch may receive a control signal having a second duty ratio more than the first duty ratio, and then supplies the second reset pulse.

The highest voltage of the second reset pulse may be higher than the highest voltage of the first reset pulse.

The driver may supply the second reset pulse in at least one subfield of all of subfields of the second frame.

The first frame and the second frame may be consecutive frames.

The variation may be equal to a difference between an average picture level (APL) of the video data of the first frame and an APL of the video data of the second frame.

A method of driving a plasma display apparatus comprising an electrode, the method comprises calculating a variation between a load of video data of a first frame and a load of video data of a second frame, comparing the variation with a threshold value, and supplying a second reset pulse to the electrode during a second flame when the variation is more than the threshold value, the second reset pulse supplied during the second frame generating a reset discharge, that is greater than a reset discharge generated by a first reset pulse supplied during the first frame.

A ratio of the threshold value to the larger load in the load of the video data of the first frame and the load of the video data of the second frame may be equal to or more than 0.2.

The variation may be equal to a difference between a sum of a gray level corresponding to each subpixel in the first frame and a sum of a gray level corresponding to each subpixel in the second flame.

The variation may be equal to a difference between a sum of an average gray level corresponding to each pixel in the first frame and a sum of an average gray level corresponding to each pixel in the second frame.

At least one of a rising slope or the highest voltage of the second reset pulse may be more than at least one of a rising slope or the highest voltage of the first reset pulse.

The first reset pulse may be supplied in response to a control signal having a first duty ratio, and the second reset pulse may be supplied in response to a control signal having a second duty ratio more than the first duty ratio.

The highest voltage of the second reset pulse may be higher than the highest voltage of the first reset pulse.

The second reset pulse may be supplied in at least one subfield of all of subfields of the second flame.

The first frame and the second flame may be consecutive flames.

The variation may be equal to a difference between an APL of the video data of the first frame and an APL of the video data of the second frame.

Hereinafter, exemplary embodiments of the present invention will be described in detail with reference to the attached drawings.

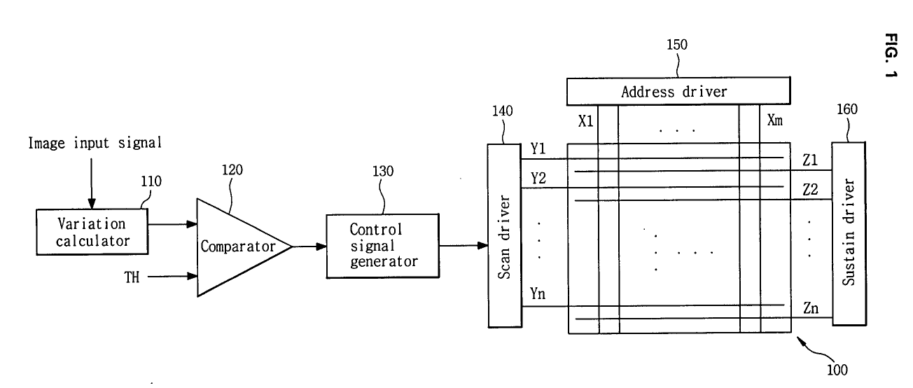

FIG. 1 illustrates a plasma display apparatus according to an embodiment As illustrated in FIG. 1, the plasma display apparatus according to the embodiment includes a plasma display panel 100, a data variation calculator 110, a comparator 120, a control signal generator 130, a scan driver 140, an address driver 150, and a sustain driver 160.

The plasma display panel 10 includes scan electrodes Y1 to Yn, address electrodes X1 to Xm, and sustain electrodes Z1 to Zn.

The data variation calculator 110 calculates a variation between a load of video data input during a first frame and a load of video data input during a second frame. The load of the video data may be equal to an average picture level (APL) in one frame or a sum of gray levels in one frame. Thus, the data variation calculator 110 according to the embodiment calculates the variation in two ways.

More specifically, the data variation calculator 10 calculates an APL of video data input during the first frame and an APL of video data input during the second frame, and then calculates a difference between the APL of the first flame and the APL of the second frame. Further, the data variation calculator 10 calculates a sum of gray levels corresponding to video data input during the first frame and a sum of gray levels corresponding to video data input during the second frame, and then calculates a difference between the sun of the gray levels of the first frame and the sum of the gray levels of the second frame.

The first frame and the second frame may be consecutive flames. For example, the first frame may be either an n-th frame or an n+1-th frame, and the second flame may be the other frame.

The comparator 120 compares the variation output from the data variation calculator 110 with a threshold value TH, and then outputs a discharge control signal when the variation is more than the threshold value TH. More specifically, the comparator 120 compares the difference between the APL of the first frame and the APL of the second frame with the threshold value TH, and then outputs a discharge control signal when the difference is more than the threshold value TH.

Further, the comparator 120 compares the difference between the sum of the gray levels of the first frame and the sum of the gray levels of the second frame with the threshold value TH, and then outputs a discharge control signal when the difference is more than the threshold value TH. The sum of the gray levels of the first frame may be equal to a sum of a gray level corresponding to each subpixel in the first frame, and the sum of the gray levels of the second frame may be equal to a sum of a gray level corresponding to each subpixel in the second frame. The sum of the gray levels of the first frame may be equal to a sum of an average gray level corresponding to each pixel in the first frame, and the sum of the gray levels of the second frame may be equal to a sum of an average gray level corresponding to each pixel in the second frame. For example, when the picture element of the plasma display panel is a pixel and one pixel includes an R-subpixel for emitting light of red type, a G-subpixel for emitting light of green type, and a B-subpixel for emitting light of blue type, the comparator 120 calculates a sum of a gray level corresponding to each of the R, G and B subpixels, or the comparator 120 calculates an average value of gray levels of the R-subpixel the G-subpixel, and the B-subpixel constituting one pixel, and then calculates a sum of an average of the gray level of each pixel.

In such a case, the threshold value TH may be set to be equal to or more than 20% of the larger APL in the APL of the first frame and the APL of the second frame. More specifically, when the APL of the second frame larger than the APL of the first frame is 200, the threshold value TH is set to 40. Thus, when the APL of the first frame is 170, the comparator 120 does not output the discharge control signal. On the other hand, when the APL of the first frame is 150, the comparator 120 outputs the discharge control signal. Further, the threshold value TH may be set to be equal to or more than 20% of the larger value in the sum of the gray levels of the first frame and the sum of the gray levels of the second frame.

The threshold value may be set to a specified value. For example, when the threshold value is set to 200 and a difference between the APL of the first frame and the APL of the second frame is more than 200, the comparator 120 outputs a discharge control signal. Further, when the threshold value is set to 1500 and a difference between the sum of the gray levels of the first frame and the sum of the gray levels of the second frame is more than 1500, the comparator 120 outputs a discharge control signal.

The control signal generator 130 receives the discharge control signal from the comparator 120. Then, the control signal generator 130 outputs a timing control signal for supplying a second reset pulse, which generates a discharge greater than a discharge generated by a first reset pulse supplied during the first flame, during the second frame.

The scan driver 140 supplies the first reset pulse and the second reset pulse to the scan electrodes Y1 to Yn. The scan driver 140 receives the timing control signal from the control signal generator 130, and then supplies the second reset pulse having a rising slope or the highest voltage more than at least one of a rising slope or the highest voltage of the first reset pulse to the scan electrodes Y1 to Yn. More specifically, when the variation between the video data input during the first flame and the video data input during the second frame is more than the threshold value TH, the scan driver 140 supplies the second reset pulse having the rising slope or the highest voltage more than at least one of the rising slope or the highest voltage of the first reset pulse to the scan electrodes Y1 to Yn. For example, the scan driver 140 may supply the second reset pulse having the rising slope more than the rising slope of the first reset pulse. The scan driver 140 may supply the second reset pulse having the highest voltage more than the highest voltage of the first reset pulse. Further, the scan driver 140 may supply the second reset pulse having the rising slope and the highest voltage more than the rising slope and the highest voltage of the first reset pulse.

The address driver 150 supplies a data pulse synchronized with a scan pulse, which the scan driver 140 supplies during an address period, to the address electrodes X1 to Xm. The supplying of the data pulse selects discharge cells to be turned on during a sustain period.

The sustain driver 160 supplies sustain pulses to the sustain electrodes Z1 to Zn during the sustain period, thereby generating a sustain discharge in the discharge cells selected during the address period. The scan driver 140 and the sustain driver 160 alternately supply the sustain pulses.

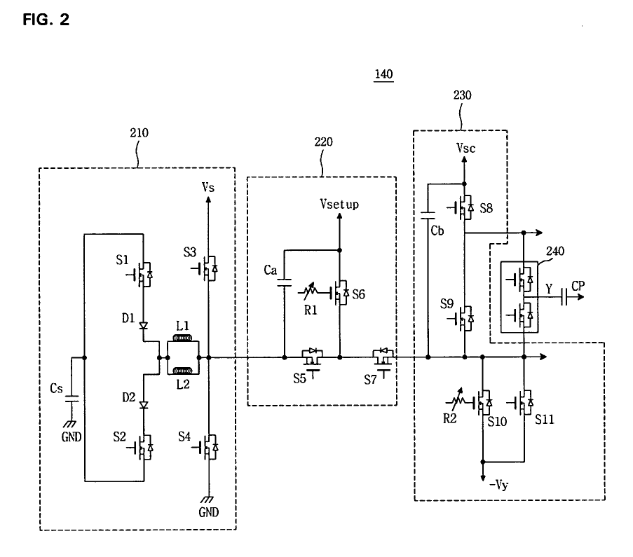

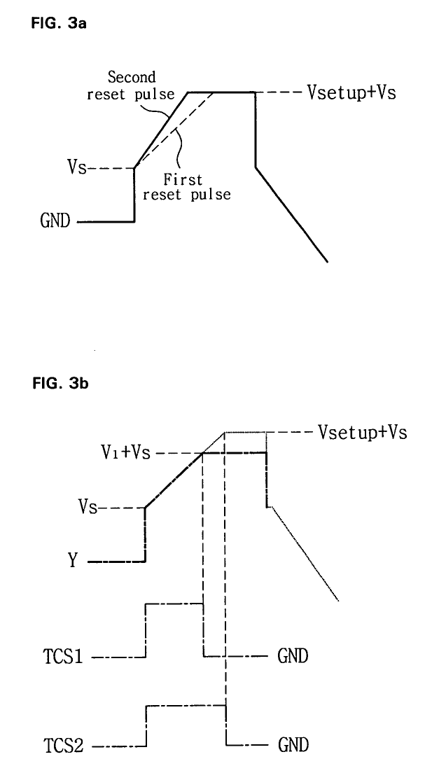

FIG. 2 illustrates a scan driver of the plasma display apparatus according to the embodiment FIGS. 3a and 3b illustrate a first reset pulse and a second reset pulse in a first frame and a second frame.

The scan driver 140 includes an energy recovery unit 210, a reset pulse supply unit 220, a driving pulse supply unit 230, and a scan drive integrated circuit (IC) 240. The energy recovery unit 210 supplies a sustain voltage or for supplying the sustain pulse during the sustain period. The energy recovery unit 210 includes an energy storing capacitor Cs, a power supply switch S1 a first diode D1, a power recovery switch S2, a second diode D2, a first resonance inductor L1, a second resonance inductor L2, a sustain voltage supply switch S3, and a ground level voltage supply switch S4.

The energy storing capacitor Cs stores the supplied energy or the recovered energy. The power supply switch S1 is turned on to supply energy of the energy storing capacitor Cs. When the power supply switch S1 supplies the energy of the energy storing capacitor Cs to the first resonance inductor L1, the first resonance inductor L1 and a plasma display panel Cp form resonance. The first diode D1 prevents an inverse current flowing from the first resonance inductor L1 to the power supply switch S1. The sustain voltage supply switch S3 supplies a sustain voltage Vs to the scan electrode Y. The power recovery switch S2 is turned on such that the energy recovered from the plasma display panel Cp is supplied to the energy storing capacitor Cs. When the energy is recovered from the plasma display panel Cp through the power recovery switch S2, the second resonance inductor L2 and the plasma display panel Cp form resonance. The second diode D2 prevents an inverse current flowing from the power recovery switch S2 to the second resonance inductor L2. The ground level voltage supply switch S4 supplies a ground level voltage GND to the scan electrode Y.

The reset pulse supply unit 220 includes a capacitor Ca, and fifth, sixth and seventh switches S5, S6 and S7. A voltage (Vsetup+Vs) is supplied to the scan electrode Y through a turn-on operation of the sustain voltage supply switch S3 in a state of charging the capacitor Ca to a voltage Vsetup. The sustain voltage supply switch S3, the fifth switch S5, and the seventh switch S7 are turned on such that the sustain voltage Vs is supplied to the scan electrode Y. Thus, a voltage of the scan electrode Y, as illustrated in FIG. 3a, sharply rises from the ground level voltage GND to the sustain voltage Vs.

The fifth switch S5 is turned off, and the sixth switch S6 is turned on. The sustain voltage supply switch S3 and the seventh switch S7 remain in a turn-on state. Thus, as illustrated in FIG. 3a, the first reset pulse or the second reset pulse gradually rising from the sustain voltage Vs to the voltage (Vsetup+Vs) is supplied to the scan electrode Y.

Since the sixth switch S6 operates an active region, the first reset pulse or the second reset pulse having the rising slope is supplied in the first frame or the second frame. The rising slopes of the first reset pulse and the second reset pulse are determined by a magnitude of a resistance of a variable resistor R1 connected to a gate terminal of the sixth switch S6. In other words, the magnitude of the resistance of the variable resistor R1 depends on the timing control signal of the control signal generator 130. The rising slope of the second reset pulse is more than the rising slope of the first reset pulse.

Accordingly, when the variation between the video data of the first frame and the second frame is more than the threshold value TH, the second reset pulse supplied during the second frame generates a strong reset discharge. Therefore, wall charges are uniformly formed in the discharge cells. In other words, when the variation between the video data of the first frame and the second frame is more than the threshold value TH, the strong reset discharge uniforms the wall charges inside the discharge cells during the second frame because a state of the wall charges in the first frame may affect a state of the wall charges in the second frame.

As the rising slope of the second frame increases, the duration of the reset period is reduced such that the duration of the address period or the sustain period may increase. This results in an increase in an address margin or a sustain margin.

As illustrated in FIG. 3b, the first reset pulse and the second reset pulse having the different highest voltages are supplied to the scan electrode Y such that wall charges of a uniform state may be formed in the discharge cells. More specifically, a first timing control signal TCS1 having a first duty ratio is supplied to the gate terminal of the sixth switch S6 during the first frame, and the sustain voltage supply switch S3 and the seventh switch S7 remain a turn-on state. During the turn-on operation of the sixth switch S6, the first reset pulse gradually rising from the sustain voltage Vs is supplied to the scan electrode Y.

The sixth switch S6 is turned on during the supplying of a high level signal of the first timing control signal TCS1, and the sixth switch S6 is turned off during the supplying of a low level signal of the first timing control signal TCS1. Since the first reset pulse is supplied to the scan electrode Y during the turn-on operation of the sixth switch S6, the energy is stored in the plasma display panel CP even if the sixth switch S6 is turned off. Thus, a voltage of the scan electrode Y is maintained at a voltage (V1+Vs) at a time point when the sixth switch S6 is turned off.

Further, a second timing control signal TCS2 having a second duty ratio is supplied to the gate terminal of the sixth switch S6 during the second frame, and the sustain voltage supply switch S3 and the seventh switch S7 remain a turn-on state. During the turn-on operation of the sixth switch S6, the second reset pulse gradually rising from the sustain voltage Vs is supplied to the scan electrode Y.

The sixth switch S6 is turned on during the supplying of a high level signal of the second timing control signal TCS2, and the sixth switch S6 is turned off during the supplying of a low level signal of the second timing control signal TCS2. Since the second reset pulse is supplied to the scan electrode Y during the turn-on operation of the sixth switch S6, the energy is stored in the plasma display panel CP even if the sixth switch S6 is turned off. Thus, a voltage of the scan electrode Y is maintained at a voltage (Vsetup+Vs) at a time point when the sixth switch S6 is turned off.

As illustrated in FIG. 3b, when the first reset pulse and the second reset pulse are supplied in the first frame and the second frame, respectively, the second reset pulse generates the reset discharge that is greater than the reset discharge generated by the first reset pulse. Therefore, although the variation between the video data of the first frame and the second frame is large, the wall charges are uniformly formed in the discharge cells

The driving pulse supply unit 230 supplies a set-down pulse, a scan pulse, and a scan bias voltage during the reset period and the address period. In other words, when a tenth switch S10 of the driving pulse supply unit 230 is turned on, the set-down pulse gradually falling to a voltage−Vy is supplied to the scan electrode Y. Further, an eighth switch S8 and an eleventh switch S11 are turned on, the scan bias voltage (−Vy+Vsc) is supplied to the scan electrode Y. When an eleventh switch S11 of the driving pulse supply unit 230 is turned on, a scan pulse gradually falling to a voltage −Vy is supplied to the scan electrode Y.

The scan drive IC 240 is connected to the scan electrode Y, thereby supplying a driving pulse such as the reset pulse, the scan pulse, the sustain pulse to the scan electrode Y.

Accordingly, when the variation between the video data of the first frame and the second frame is more than the threshold value TH, the second reset pulse supplied during the second frame generates the strong reset discharge. Therefore, the wall charges are uniformly formed in the discharge cells. In other words, when the variation between the video data of the first frame and the second frame is more than the threshold value TH, the strong reset discharge uniforms the wall charges inside the discharge cells during the second frame because the state of the wall charges in the first frame may affect the state of the wall charges in the second frame.

Since the timing control signals having the different duty ratios change the highest voltage of the reset pulse without a change in the circuit configuration of the scan driver 140 or without adding a component to the scan driver 140, the manufacturing time or cost of the plasma display apparatus is reduced.

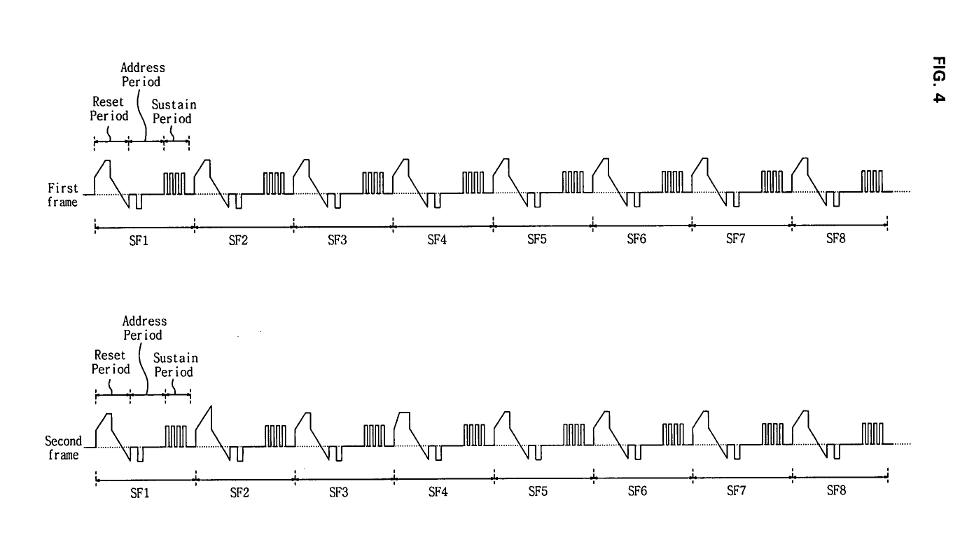

FIG. 4 illustrates a subfield in which a second reset pulse is supplied. As illustrated in FIG. 4, the scan driver 140 supplies the second reset pulse in at least one subfield (for example, subfields SF2 and SF4) of all of subfields SF1 to SF8 of the second frame. More specifically, the scan driver 140 may supply the second reset pulse in each subfield SF1 to SF8 of the second frame, or the scan driver 140 may supply the second reset pulse in at least one subfield of all the subfields SF1 to SF8 of the second frame. The second reset pulse supplied during the second frame has the rising slope or the highest voltage more than at least one of the rising slope or the highest voltage of the first reset pulse supplied during the first frame. For example, the second reset pulse having the highest voltage more than the highest voltage of the first reset pulse may be supplied in the subfield SF2 of the second frame. The second reset pulse having the rising slope more than the rising slope of the first reset pulse may be supplied in the subfield SF2 of the second frame.

The embodiment of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus, comprising:
a plasma display panel comprising an electrode; and
a driver for supplying a second reset pulse to the electrode during a second frame when a variation between a load of video data of a first frame and a load of video data of the second frame is more than a threshold value, the second reset pulse supplied during the second frame generating a reset discharge, that is greater than a reset discharge generated by a first reset pulse supplied during the first flame.

2. The plasma display apparatus of claim 1, wherein a ratio of the threshold value to the larger load in the load of the video data of the first frame and the load of the video data of the second flame is equal to or more than 0.2.

3. The plasma display apparatus of claim 1, wherein the variation is equal to a difference between a sum of a gray level corresponding to each subpixel in the first frame and a sum of a gray level corresponding to each subpixel in the second frame.

4. The plasma display apparatus of claim 1, wherein the variation is equal to a difference between a sum of an average gray level corresponding to each pixel in the first frame and a sum of an average gray level corresponding to each pixel in the second flame.

5. The plasma display apparatus of claim 1, wherein the driver sets at least one of a rising slope or the highest voltage of the second reset pulse to be more than at least one of a rising slope or the highest voltage of the first reset pulse.

6. The plasma display apparatus of claim 1, wherein the driver comprises a switch for supplying the first reset pulse and the second reset pulse,
the switch receives a control signal having a first duty ratio, and then supplies the first reset pulse, and
the switch receives a control signal having a second duty ratio more than the first duty ratio, and then supplies the second reset pulse.

7. The plasma display apparatus of claim 6, wherein the highest voltage of the second reset pulse is higher than the highest voltage of the first reset pulse.

8. The plasma display apparatus of claim 1, wherein the driver supplies the second reset pulse in at least one subfield of all of subfields of the second frame.

9. The plasma display apparatus of claim 1, wherein the first frame and the second frame are consecutive frames.

10. The plasma display apparatus of claim 1, wherein the variation is equal to a difference between an average picture level (APL) of the video data of the first frame and an APL of the video data of the second frame.

11. A method of driving a plasma display apparatus comprising an electrode, the method comprising:
calculating a variation between a load of video data of a first frame and a load of video data of a second frame;
comparing the variation with a threshold value; and
supplying a second reset pulse to the electrode during a second frame when the variation is more than the threshold value, the second reset pulse supplied during the second frame generating a reset discharge, that is greater than a reset discharge generated by a first reset pulse supplied during the first frame.

12. The method of claim 11, wherein a ratio of the threshold value to the larger load in the load of the video data of the first frame and the load of the video data of the second frame is equal to or more than 0.2.

13. The method of claim 11, wherein the variation is equal to a difference between a sun of a gray level corresponding to each subpixel in the first frame and a sum of a gray level corresponding to each subpixel in the second frame.

14. The method of claim 11, wherein the variation is equal to a difference between a sum of an average gray level corresponding to each pixel in the first frame and a sum of an average gray level corresponding to each pixel in the second frame.

15. The method of claim 11, wherein at least one of a rising slope or the highest voltage of the second reset pulse is more than at least one of a rising slope or the highest voltage of the first reset pulse.

16. The method of claim 11, wherein the first reset pulse is supplied in response to a control signal having a first duty ratio, and the second reset pulse is supplied in response to a control signal having a second duty ratio more than the first duty ratio.

17. The method of claim 16, wherein the highest voltage of the second reset pulse is higher than the highest voltage of the first reset pulse.

18. The method of claim 11, wherein the second reset pulse is supplied in at least one subfield of all of subfields of the second frame.

19. The method of claim 11, wherein the first frame and the second frame are consecutive frames.

20. The method of claim 11, wherein the variation is equal to a difference between an APL of the video data of the first flame and an APL of the video data of the second frame.
